(19) United States
(12) Patent Application Publication
(10) Pub. No.: US 2025/0094500 A1
(43) Pub. Date: Mar. 20, 2025

(54) Method and apparatus for selecting and/or optimizing models for data sets

(71) Applicant: EFFEX BV, Leuven (BE)

(72) Inventors: José Núñez Ares, Leuven (BE); Peter Philiep Goos, Heverlee (BE)

(73) Assignee: EFFEX BV, Leuven (BE)

(21) Appl. No.: 18/592,606

(22) Filed: Mar. 1, 2024

Related U.S. Application Data
(60) Provisional application No. 63/583,877, filed on Sep. 20, 2023.

(51) Int. Cl. G06F 16/904

(52) U.S. Cl. CPC G06F 16/904

(57) ABSTRACT

A computer-implemented method for modelling a data set using a graphical interface, is provided, the method comprising displaying, in a display screen by an operating system, a heatmap plot for a plurality of inputs and a plurality of mathematical models, the heatmap plot comprising a plurality of cells wherein each cell corresponds to an input of the plurality of inputs and a mathematical model of the plurality of mathematical models, wherein each cell comprises a visual indication of the sign and absolute value of a value associated the corresponding input, wherein each of the mathematical models describes the relation between and the plurality of inputs and the plurality of outputs wherein the plurality of inputs are inputs of a system or process and the plurality of responses are outputs of the system or process affected by variations in the inputs.

### FIELD OF THE INVENTION

The invention relates to a method and apparatus for a graphical interface for selecting a model for a data set. The invention further relates to a method and apparatus for a graphical interface for optimizing a model for a data set.

### BACKGROUND OF THE INVENTION

Data analysis and optimization deals with challenges where a set of input parameters (also called independent variables or factors) influence a product, a process, or a system which is characterized by several output measures (also called dependent variables or responses).

Data analysis is a broad term that consists of several techniques that have as goal the discovery of the relationships hidden in a dataset. This is a complex and challenging task as several mathematical models may show similar statistical qualities.

### SUMMARY OF THE INVENTION

According to a first aspect of the invention, a computer-implemented method for modelling a data set using a graphical interface, is provided, the method comprising displaying, in a display screen by an operating system, a heatmap plot for a plurality of inputs and a plurality of mathematical models, the heatmap plot comprising a plurality of cells wherein each cell corresponds to an input of the plurality of inputs and a mathematical model of the plurality of mathematical models, wherein each cell comprises a visual indication of the sign and absolute value of a value associated the corresponding input, wherein each of the mathematical models describes the relation between and the plurality of inputs and the plurality of outputs wherein the plurality of inputs are inputs of a system or process and the plurality of responses are outputs of the system or process affected by variations in the inputs.

The visual indication may comprises a colour. The colour may be different depending on whether the sign of the corresponding value is positive or negative. The colour of a first cell of the plurality of cells may be darker than the colour of a second cell of the plurality of cells if the absolute value of the corresponding effect for the first cell is greater than the absolute value of the corresponding effect for the first cell.

The plurality of effects may comprise a intercept effect and the method may further comprise displaying, in a display screen by an operating system, graphical controls for selecting whether the heatmap plot displays a constant input among the plurality of inputs and/or cells among the plurality of cells corresponding to inputs that have a zero value for each of the plurality of mathematical models and/or cells corresponding to mathematical models comprising a predetermined statistical quality parameter; receiving, by the operating system, a user input for one of the graphical controls; and displaying, in the display screen by the operating system, the heatmap plot modified according to the user input.

According to an embodiment, the computer-implemented method may further comprise displaying, by the processing unit in the display screen, a parallel coordinate plot for the plurality of mathematical models, the parallel coordinate plot comprising a plurality of vertical axis corresponding to a plurality of quality indicators of the plurality of mathematical models, and a linear function connecting the plurality of quality indicators, receiving a user input selecting to display mathematical models comprising a quality indicator among the plurality of quality indicators, modifying the heatmap plot and the parallel coordinate plot based on the user input such that only the mathematical models comprising the selected quality indicator are displayed.

The computer-implemented method may also comprise receiving a user input selecting to show mathematical models among the plurality of mathematical models comprising a transformation of an outcome among the plurality of outcomes, and modifying the parallel coordinate plot based on the user input.

According to another embodiment, the computer-implemented method may comprise receiving a user input selecting cells corresponding to a certain value or range of values among the plurality of cells, and modifying the heatmap plot and the parallel coordinate plot based on the user input.

In a further embodiment, the computer-implemented method may comprise receiving a user input selecting a certain range in one or more of the axis of the parallel coordinate plot, and modifying the heatmap plot based on the user input.

According to a second aspect of the invention, a computer-implemented method for statistical modelling optimization is provided, the method comprising receiving, by a processing unit, a set of specifications for a plurality of outputs, and displaying, by the processing unit in a display screen, a parallel coordinate plot with a plurality of vertical axis corresponding to a plurality of inputs, the plurality of outputs calculated using a plurality of mathematical models, and a measure of compliance of the calculated outputs with the set of specifications.

According to an embodiment, the computer-implemented method may comprise receiving, by the processing unit, a user input for at least one of the plurality of inputs; and modifying, by the processing unit, the parallel coordinate plot based on the user input; wherein the user input corresponds to a constraint for the at least one of the inputs.

According to another embodiment, the computer-implemented method may further comprise receiving, by the processing unit, a further user input for at least one of the outcomes comprising an optimization direction that can be a minimization, a maximization, or an interval of the outcome, and modifying, by the processing unit, the parallel coordinate plot based on the user input.

According to the disclosure a computer-implemented method for statistical modelling optimization is provided, the method comprising receiving, by the processing unit, a plurality of inputs, each of the plurality of inputs corresponding to a continuous value or a categorical value, wherein the categorical value corresponds to a finite set of categories, receiving, by a processing unit, a set of conditions for a plurality of outputs, for each of the plurality of inputs corresponding to a continuous value, receiving a discretization number, and displaying, by the processing unit in a display screen, a parallel coordinate plot comprising a vertical axis for each of the plurality of inputs, each of the plurality of outputs, and for at least one measure of compliance, each vertical axis comprising a number of points, and wherein the parallel coordinate plot further comprises lines connecting at least one point of each vertical axis with at least one point of the neighbouring vertical axis; wherein the number of points of a vertical axis corresponding to an input among the plurality of inputs corresponding to a continuous value is calculated on the discretization value received for said input, the number of points of an input comprising a categorical value is based on the corresponding finite set of categories of said input, each of the points of a vertical axis of an output corresponds to a selection of a specific point in each vertical axis corresponding to an input and is calculated using a mathematical model corresponding to said input, and the at least one measure of compliance indicates a compliance of the calculated outputs with the set of conditions.

The computer-implemented method may further comprise receiving, by the processing unit, a user input for at least one of the plurality of inputs, the plurality of outputs and the measure of compliance; and modifying, by the processing unit, the parallel coordinate plot based on the user input; wherein the user input corresponds to a constraint for the at least one of the inputs, the plurality of outputs and the measure of compliance, and modifying the parallel coordinate plot comprises providing a visual indication of the lines in the parallel coordinate plot connecting points of the vertical axis complying with the constraint.

The output among the plurality of outputs may comprise continuous values, a condition among the set of conditions corresponding to said output comprises an optimization direction that can be a minimization, a maximization, or an interval of the output given by an upper and a lower bound for a numerical value of said output.

The output among the plurality of outputs may comprise categorical values within a finite set of categories, a condition among the set of conditions corresponding to said output comprises limiting the categorical value of said output to one or more categories among the finite set of categories.

The measure of compliance may comprise at least one of a probability of the plurality of outputs complying with the set of conditions, a tolerance interval for said probability, a number of false positives or false negatives, a measures of robustness, or desirability function values.

The vertical axis and/or one of the lines may comprise visual information indicating a value of the measure of compliance. The visual information may indicating higher values of the measure of compliance may comprise a first colour and visual information indicating lower values of the measure of compliance may comprise a second colour different from the first colour.

The invention further relates to an apparatus comprising a processing unit, a memory, and a display wherein the processing unit is arranged to perform the above-described method.

### BRIEF DESCRIPTION OF THE DRAWINGS

The invention will be described further with respect to embodiments shown in the drawings.

FIG. 1 shows a schematic of a system with inputs and outputs.

FIG. 2 shows a schematic of a system for selecting models and optimizing models for data sets.

FIGS. 3-5 show heatmap plots of effects for mathematical models according to embodiments of the invention.

FIGS. 6-12 show heatmap and parallel coordinate plots together with screen graphical controls for model selection according to embodiments of the invention.

FIG. 13 shows how the specifications are set in the graphical interface according to an embodiment of the invention.

FIGS. 14-16 show parallel coordinate plots for optimization of models together with screen graphical controls according to another aspect of the invention.

### DESCRIPTION

The following is a description of certain embodiments of the invention, given by way of example only and with reference to the figures. It is also to be understood that the terminology used herein is for the purpose of describing particular aspects only and is not intended to be limiting.

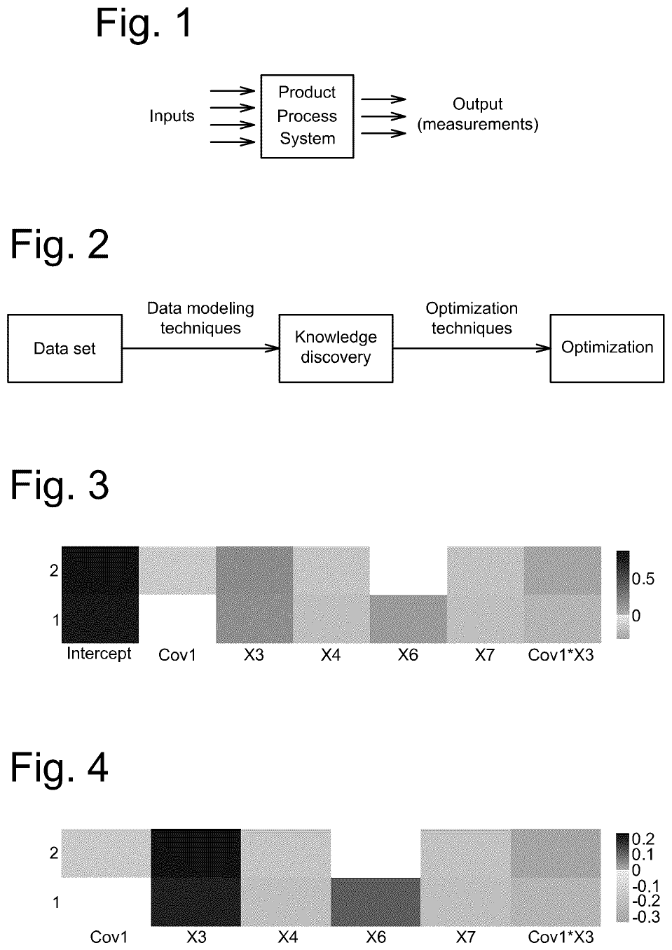

In general, data analysis and optimization deals with challenges where a set of input parameters (also called independent variables or factors) influence a product, a process, or a system which is characterized by several output measures (also called dependent variables or responses). FIG. 1 shows a schematic of a system, process or product with inputs and outputs.

Data analysis is a broad term that consists of several techniques that have as goal the discovery of the relationships hidden in a dataset. FIG. 2 shows a The rest of the description will describe the data analysis techniques showing in FIG. 2, this is, data modeling techniques that find a mathematical model that quantifies the relation between the inputs in the form of a data set and the outputs which are called knowledge discovery in FIG. 2, and optimization techniques that take those obtained mathematical models to choose the best values for the inputs to optimize the outputs. The data an apparatus for knowledge discovery and an apparatus for optimization. Each of those apparatus may comprise a processing unit, a memory and a display wherein the processing unit is arranged to perform the below-described methods. Moreover, the apparatus for knowledge discovery and the apparatus for optimization may be the same apparatus comprising a processing unit, a memory and an input/output unit comprising a display wherein the processing unit is arranged to perform any of the below-described methods.

The apparatus may comprise a communication unit. The processing unit may comprise a Central Processing Unit, CPU, which is connected to the input/output unit, the memory, the communication unit. The input/output unit may comprise any known device to allow an operator to generate data and instructions for the processing unit, like a keyboard, a mouse, one or more touch screens, etc. The input/output unit may comprise any suitable output device to output data to an operator including the display, etc. The memory may comprise any suitable known memory devices to store data and computer programs to be run on the procesor unit, and may include any known type of volatile and non-volatile memory equipment, RAM and ROM types of memories, etc. The computer programs comprise instructions to be loaded by the processing unit. The communication unit is configured to transmit signals to and receive signals from equipment outside the processing unit. Any known and suitable transceiver equipment can be used for that purpose using any known or still to be developed (standard) communication technique including 2G, 3G, 4G, 5G, Wifi, Bluetooth, NFC, etc. To that end the communication unit may be connected to a network and an antenna.

The description will describe several embodiments related to a novel interactive graphical interface for data modeling and optimization to assist the user.

### Data Analysis

Data analysis aims to discover knowledge about a system and to draw conclusions to achieve a better performance. There are many different types of data analysis, and in this invention we focus on those that produces a mathematical model that explains the system data.

The starting point for obtaining a mathematical model is a dataset. A dataset consists of a table with a number of rows and a number of columns. Each row of the table is an observation or test, and each column of the table is a variable. The variables are of two kinds, independent variables or dependent variables. The dependent variables are influenced by the independent variables, and this influence is quantified by the mathematical model. The dataset can be constructed in two different ways. On the one hand, the data is obtained from an observational study where there was no deliberate choice of the values for the independent variables in the dataset. On the other hand, the data is obtained from a designed experiment where the levels of the independent variables have been carefully chosen to maximize the capture of information at a minimal cost. Sometimes the dataset has some columns that have been observed, and some other columns that have been carefully planned.

The data analysis is an instrument to achieve the following goals, depending on the nature of the data set:
For an observational dataset: identify and quantify the influence of the independent variables in the dependent variables,
For a dataset obtained from a designed experiment: identify and quantify the influence of the independent variables in the dependent variables, and optimize the values for the independent variables such that the dependent variables lie within pre-defined specifications.

Now we present several cases of datasets both from observational and experimental data.

### MOTIVATING EXAMPLE 1

Researchers in education wants to study whether a certain educational intervention has an influence in the test score of the students. To this end, the researcher collects observational data for students that have either been subject to the intervention, or belong to a control group. The researchers also collect other data like the student GPA, the student previous grade in a similar class, and the results of a test done before the educational intervention. The independent variables in this case are: student GPA score, student result in the pre-test, prior grade of the student in another class, and whether the student has been subject to the intervention or the student belongs to the control group. The dependent variable is the test score of each student after the intervention. Using a modeling technique known as linear regression, the researchers are able to quantify the influence of the educational intervention in obtaining a higher grade in the final test. Details can be found in “Is it the intervention or the students? Using linear regression to control for student characteristics in undergraduate STEM education research”, by Theobald, R., & Freeman, S. (2014) in CBE—Life Sciences Education, 13 (1), 41-48.

The goal of this observational study was to quantify the effect of the independent variables in the dependent variable, and to this end, an analysis technique known as linear regression was used.

### MOTIVATING EXAMPLE 2

Consider the following problem in a chemical industry. Due to new regulations, a product from a chemical company is not compliant to more strict specifications imposed by the regulatory agencies. Therefore, the company needs to redefine their production process to ensure that the end product properties lie within the specifications, otherwise they will not able to commercialize it. To this end, the company plans an experiment in the production line in order to find an optimal set of operating conditions.

The company identifies the most important independent variables that affect the process, and the specifications of the end product that will make it compliant with the new regulations. The data from the experiment is collected, and analyzed using linear regression modeling. The company finds a mathematical model that determines the relation between the independent and the dependent variables, and optimizes the model to find the set of operating conditions such that the product made lies within specifications with the highest probability of success.

The goal in this data analysis is to identify the influence of the independent variables by setting a statistical model, and then optimize the statistical model to obtain the best set of operating conditions (values for the independent variables), to obtain a product with the highest quality.

### Analysis Techniques

The different analysis techniques presented here aim to find a mathematical model that relates independent and dependent variables. Different types of modeling techniques can be considered. In Table 1 a list is provided with modeling techniques that can be used for data modeling.

The list is not comprehensive, but it contains the most representative model selection techniques used nowadays. The list shown in table 1 are modeling techniques that can be applied to an observational dataset of a dataset obtained from a designed experiment.

TABLE 1
Modeling techniques
Linear regression
Logistic regression
Generalized linear
regression
Random forest
Correlation analysis
Bayesian regression
Multivariate regression
Mixed-effects modeling
Regression trees
Support vector machines
Artificial neural networks

The advantage of having such a model is that if allows the prediction of the behavior of the system of study for values of the independent that have not been tested.

### Linear Regression Modeling

In our two motivation examples, the modeling technique chosen was linear regression. In what follows, we will use the word “factor” to denote an independent variable, and the word “response” to identify a dependent variable.

Linear regression allows the quantification of the influence of the factors in the responses, by estimating the individual influence of different types of effects. We first have what it is called the intercept, or the constant effect. The intercept quantifies the average value for the response. Then there are the “main effects” or “linear effects”. A main effect of a certain factor quantifies the amount of change in one or several responses for each unit of change of the factor. Then we have what is called the “two-factor interaction effects”. A estimation of a two-factor interaction effects between factor A and factor B quantifies the extent to which the effect of factor A depends on the level of factor B, and vice versa. Finally, the “quadratic effect” of a numerical factor A quantifies the curvature in the relation between the factor A and the response(s).

In general, a linear regression model that is estimated from experimental data is a mathematical equation which can be represented using the following symbols:
y denotes the response.
x₁, x₂, . . . , xₘ denote the m factors.
ϵ denotes the experimental error, which follows a normal distribution with a variance equal to σ², and a mean of zero.

With this symbols, the general mathematical expression of a linear regression model that considers main, two-factor interaction and quadratic effects on all factors, and assuming that all factors are numerical, equals

$${y}_{i} = {β}_{0} + {\sum }_{j = 1}^{m} {β}_{j} \cdot {x}_{j i} + {\sum }_{j = 1}^{m - 1} {\sum }_{k = j + 1}^{m} {β}_{j k} \cdot {x}_{j i} \cdot {x}_{k i} + {\sum }_{j = 1}^{m} {β}_{j j} \cdot {x}_{j i}^{2} + ε ,$$

where yᵢ is the value of the response y at the factors values combination i, xⱼ is the factor indexed by j, xᵢⱼ is the value of factor xⱼ for the factors values combination i, β₀ is the intercept which equals the average response value, βⱼ is the main effect of factor xⱼ, βⱼₖ with k different than j is the two-factor interaction effect between factors xⱼ and xₖ, βⱼⱼ is the quadratic effect of factor xⱼ, and, finally, ϵ is the random error as defined previously. The set of β₀, βⱼ, βⱼₖ and Bⱼⱼ is denoted as the β coefficients.

The β coefficients are estimated using least squares estimation. The estimate of β₀, βⱼ, βⱼₖ and βⱼⱼ are respectively denoted as \hat{β}₀, \hat{β}ⱼ, \hat{β}ⱼₖ and \hat{β}ⱼⱼ. The set of estimates \hat{β} ₀, \hat{β}ⱼ, \hat{β} ⱼₖ and \hat{β} ⱼⱼ is denoted as the coefficient estimates \hat{β}. Therefore, once the model has been estimated, the expression for the predicted value of a response at a certain factors values combination i equals:

$${\hat{y}}_{i} = {\hat{β}}_{0} + {\sum }_{j = 1}^{m} {\hat{β}}_{j} \cdot {x}_{j i} + {\sum }_{j = 1}^{m - 1} {\sum }_{k = j + 1}^{m} {\hat{β}}_{j k} \cdot {x}_{j i} \cdot {x}_{k i} + {\sum }_{j = 1}^{m} {\hat{β}}_{j j} \cdot {x}_{j i}^{2}$$

This expression allows the prediction of response values for factors values combinations that have not been tested, and it is the base for the data analysis step and the optimization step when the dataset is coming from a designed experiment.

The coefficient estimates (denoted as \hat{β}) are real values (negative, zero or positive), and quantify the constant, main, two-factor interactions and quadratic effects of all factors involved.

Each estimate in \hat{β} has an associated p-value, which indicates the significance of the addition of the corresponding effect in the model. The lower the p-value the better, as it indicates that the addition of the corresponding effect helps explaining the variability of the response and minimizing the variance of the error term ϵ.

### The Challenge of Finding a Good Linear Regression Model

A second-order effects model is a linear regression model that contains an intercept, main effects for all factor, all two-factor interactions, and all quadratic effects. Given that there are m factors, the number of different effects in a second-order effects model equals:
1 intercept,
m main effects,

$$\frac{m \cdot ( m - 1 )}{2}$$

two-factor interaction effects, and
m quadratic effects.

The challenge of finding a good linear regression model consists of choosing the most important effects to be included in the model. Clearly, an effect can be either in the model or not in the model, and therefore, the set of possible models has a size equal to two to the power of the number of effects.

Table 2 gives the number of effects in a second-order effects model, and the number of possible models for a number of factors that goes from 1 to 11 factors.

TABLE 2

| | | | | | | | | | | | |
|---|---|---|---|---|---|---|---|---|---|---|---|
| Number of | 1 | 2 | 3 | 4 | 5 | 6 | 7 | 8 | 9 | 10 | 11 |
| factors | | | | | | | | | | | |
| Number of | 3 | 6 | 10 | 15 | 21 | 28 | 36 | 45 | 55 | 66 | 78 |
| effects | | | | | | | | | | | |
| Number of | 8 | 64 | 1024 | 32768 | 2.1E+06 | 2.7E+08 | 6.9E+10 | 3.5E+13 | 3.6 + 16 | 7.4 + 19 | 3 + 23 |
| possible | | | | | | | | | | | |
| models | | | | | | | | | | | |

If one would like to check all different models for a problem with 11 factors, then it will be necessary to evaluate 2⁷⁷=3·10²³ models, which is clearly not feasible. Therefore, different algorithmic model selection methods can be used to find the best effects to be included in a linear regression model. A few examples of model selection techniques are forward/backward/mixed stepwise model selection of which “The analysis and selection of variables in linear regression” by Hocking, R. R. (1976) Biometrics invited paper in Biometrics, 1-49 provides an example, a Dantzig model selection of which “Decoding by linear programming” by Candes, E. J., & Tao, T. (2005), IEEE transactions on information theory, 51 (12), 4203-4215 provides an example, a Lasso model selection of which “Regression shrinkage and selection via the lasso” by Tibshirani, R. (1996), Journal of the Royal Statistical Society Series B: Statistical Methodology, 58 (1), 267-288provides an example, a best subsets model selection of which “Best subset selection via a modern optimization lens” by Bertsimas, D., King, A., & Mazumder, R. (2016) and “A mixed integer optimization approach for model selection in screening experiments” by Vazquez, A. R., Schoen, E. D., & Goos, P. (2021), Journal of Quality Technology, 53 (3), 243-266 provide an example, or Elastic-Net model selection of which “Regularization and variable selection via the elastic net” by Zou, H., & Hastie, T. (2005), Journal of the Royal Statistical Society Series B: Statistical Methodology, 67 (2), 301-320, provides an example.

### Transformations of the Response

Sometimes it is necessary to transform the response data to improve the quality of the obtained models. Usual transformations that are performed on the response are to take the square root of the values, to square them, to take the logarithm, or to do a logit transformation.

### Statistical Quality Indicator of a Linear Regression Model

The quality of a linear regression model is characterized by using different metrics. The following attributes are the most commonly used to characterize this kind of models.
the degrees of freedom used to estimate the model,
coefficient of determination, denoted as R²,
adjusted coefficient of determination, denoted as adj R²,
the corrected Akaike information criterion, denoted as AICc,
the Bayesian Information Criterion, denoted as BIC,
the PRESS value,.
or if whether the model exhibits weak, strong or no heredity.
   Next we explain each one of the statistical quality indicators for a linear regression model:
The degrees of freedom to estimate the model equals the number of nonzero estimates and it is denoted as p.
R² (“R squared”) quantifies the proportion of variation in the dependent variable that is explained by the independent variables. The calculation of R² equals

$${R}^{2} = 1 - \frac{{SS}_{res}}{{SS}_{total}}$$

where SSᵣₑₛ is the residual sum of squares and equals
SSᵣₑₛ=Σᵢ₌₁ⁿ (yᵢ−ŷᵢ)², and SSₜₒₜₐₗ is the total sum of squares and equals
SSₜₒₜₐₗ=Σᵢ₌₁ⁿ (yᵢ−y̅)².
The adjusted R², also denoted as R_{adj}², equals

$${R}_{adj}^{2} = 1 - ( 1 - {R}^{2} ) \cdot \frac{n - 1}{n - p - 1} ,$$

where n is the number of test or observations in the dataset.
The corrected Akaike Information Criterion (AICc) is calculated from the Akaike Information Criterion (AIC) which equals:
AIC=2·p−2·In (\hat{L}), where \hat{L} is the likelihood function value.
Then

$$AICc = AIC + \frac{2 \cdot {p}^{2} + 2 \cdot p}{n - p - 1}$$

The Bayesian Information Criterion (BIC) equals

$$BIC = p \cdot ln ( n ) - 2 \cdot 2 \cdot ln ( \hat{L} ) .$$

The PRESS statistic equals PRESS=Σᵢ₌₁ⁿ (yᵢ−ŷ₋ᵢ)², where ŷ₋ᵢ is the predicted value at factor values combination i from a linear regression model that is fitted without taking the value yᵢ into account.
A model exhibits strong heredity when:
   If there is a two-factor interaction effect in the model, the main effects of the involved factors in the two-factor interaction effect are also present in the model, and
   If there is a quadratic effect in the model, then the factor involved in the quadratic effect is also in the model.
A model exhibit weak heredity when
   If there is a two-factor interaction effect in the model, at least one of the main effects of the involved factors in the two-factor interaction effect is also present in the model, and
   If there is a quadratic effect in the model, then the factor involved in the quadratic effect is also in the model.
A model exhibits no heredity when it does not exhibit strong or weak heredity.

### Often Different Models Are, Statistically Speaking, Equally Good

It is often the case that the model selection methods mentioned in the last paragraph produce linear regression models that have a similar statistical quality while containing different sets of effects. The disclosure deals with this situation by presenting graphically a set of good models, with interacting graphs, that can be used as a support decision making tool by the people involved in the data analysis.

### Our Interactive Graphical Tool for Model Selection

The input for our graphical tool is a set of models that relate independent and dependent variables for a defined transformation of the response. Each model from the set is defined by the following characteristics:
A set of effects that is included in the model, together with a numerical quantification of their influence.
Numerical values that quantify the quality of the model

These characteristics are used to build the interactive two graphs that we will now explain.

The first graph is a heatmap, and there the different models are displayed. In the heatmap, there is a row for each model in the set of models, and each column corresponds to one of the potential effects that can be included into a model. Each cell, therefore, corresponds to a specific model and a specific effect. The cell gets a color that depends on the numerical quantification of their influence in the model. For example, for linear regression models, the quantity used can be either the estimate of the effect, or the p-value of the effect.

The second graph is a parallel coordinate plot, which is a graph that consists of a number of vertical axis and one piecewise linear function from left to right for each one of the models in the set of models. The piecewise linear function connects the values for each model from contiguous axis.

The interaction between the graphs is done in two different ways:
First, the initial set of the models can be filtered by using commands that are located next to the graphs. In these commands a user can select to display models that have weak, strong or no heredity (or any combination of these). Similarly, a user can select to show models for one transformation of the response at a time, with a control widget that can be, for example, a dropdown menu. As the sets of models are different for each transformation of the response, when a user changes the selection of the transformation of the response, the parallel coordinate plot will also be updated with the corresponding set of models. The user can also select which numerical quantification of the influence of each effect is to be selected to color the cells of the heatmap. The user can also indicate with a widget like, for example, a radio button, that the column corresponding to the intercept should not be included in the heatmap. The user can indicate with a widget like, for example, a radio button, that the columns of effects that appear in no model should not be included in the heatmap.
Second, a user can select a certain range in one or more axis of the parallel coordinate plot, and the selected models are then used to build the heatmap.

### Numerical and Categorical Factors

Our interactive graphical tool can be also used to display the influence the effects built from both numerical and categorical factors. Numerical factors are those that can take any real value contained in a given range, while categorical factors can take values within a finite set of alternatives or categories. The temperature, for example, is a numerical factor. The job of a certain person is a categorical factor.

### Motivating Example

As an example, consider the following problem in a chemical industry. Due to new regulations, a product from a chemical company is not compliant to more strict specifications imposed by the regulatory agencies. Therefore, the company needs to redefine their production process to ensure that the end product properties lie within the specifications, otherwise they will not able to commercialize it. To this end, the company plans an experiment in the production line in order to find an optimal set of operating conditions.

In the first phase (Preparation), the subject matter experts and the statisticians gather to define the experimental conditions. These conditions consists of:
what are the parameters that can be set will likely influence the production process (controllable factors) and what is the range of values that they want to study, together with the nature of the factors, which can be numerical (taking real values), or categorical (taking values within a specified finite set of categories),
how will the production process quality be measured (responses) and what are the desired specifications,
what is the goal of the experiment, which can be, in general, screening and/or optimization,
what is the budget for the number of tests in the experiment, and
any other particularity that needs to be taken into account for the experiment like, for example, the use of different batches of raw material, or the existence of day-to-day variability that may affect the results of the experiment when the tests are carried out in several days.

In our example, the process engineers and the statisticians come together to discuss the conditions of the experiment. In the end, they define the experimental conditions as follows:
the following list of eight numerical factors should be taken into account: Water, amount of two different acids, amount of base, amount of solvent, temperature of the oven, time in the oven, and the pressure. The process engineers and statisticians also decide what is the range for each factor that they want to study as shown in the example of table 3.

TABLE 3

| Factor name | Factor range |
|---|---|
| Water (l) | [30, 40] |
| Acid 1 (mg/l) | [80, 90] |
| Acid 2 (mg/l) | [500, 1000] |
| Base (mg/l) | [0, 2] |
| Amount solvent (mg/l) | [160, 210] |
| Temperature oven (° C.) | [300, 510] |
| Time in the oven (h) | [2, 4] |
| Pressure (MPa) | [13, 15] |

after every test, the following four properties on the end product will be measured: residual left in the product, density, thermal degradation, and extrusion pressure. These are all numerical responses, and it is desired that the residual is minimal, the density lies within a given range, the thermal degradation should not be higher than a given upper bound, and, finally the extrusion pressure should be within a given range of values.
The goal of the experiment is two-fold, on one hand, it is desired to do screening to identify the factors that matter the most for each one of the responses, and, on the other hand, it is desired to find an optimal set of operating conditions for the factors such that all responses lie within specifications.
The budget of the experiment limits the number of tests that can be carried out to 24.
There is raw material involved in the experiment which is characterized by two numerical attributes: the moisture, the particle size and the age. These are inputs that will likely influence the response, but that cannot be controlled as they depend on the raw material used. This is why these attributes are called, in statistical terms, uncontrollable factors or covariates.

In the second phase (Setting up the experiment), the statistician and the rest of the stakeholders find an experimental design that fulfils the conditions set beforehand. An example of such an experimental design is depicted in Table 4 below. There, each row of the table is a test where each cell indicates what are the values of the factors that will be used. The values of the factors lie within the ranges given during the preparation of the experiment (Step 1). The experimental design in Table 4 has 24 tests, which lies within the specified budget.

TABLE 4

| | | | | | Amount | Temperature | Time in | |
|---|---|---|---|---|---|---|---|---|
| | Water | Acid 1 | Acid 2 | Base | solvent | oven | the oven | Pressure |
| Test | (l) | (mg/l) | (mg/l) | (mg/l) | (mg/l) | (° C.) | (h) | (MPa) |
| 1 | 30 | 90 | 1000 | 0 | 160 | 510 | 2 | 15 |
| 2 | 40 | 80 | 1000 | 0 | 160 | 510 | 4 | 13 |
| 3 | 35 | 90 | 500 | 2 | 210 | 510 | 4 | 13 |
| 4 | 40 | 90 | 1000 | 2 | 260 | 510 | 4 | 15 |
| 5 | 35 | 85 | 500 | 2 | 160 | 510 | 2 | 13 |
| 6 | 40 | 90 | 500 | 0 | 160 | 300 | 4 | 14 |
| 7 | 35 | 85 | 1000 | 2 | 210 | 405 | 2 | 13 |
| 8 | 40 | 85 | 1000 | 0 | 260 | 405 | 2 | 13 |
| 9 | 30 | 80 | 500 | 0 | 260 | 510 | 4 | 14 |
| 10 | 35 | 85 | 500 | 0 | 210 | 405 | 4 | 15 |
| 11 | 30 | 85 | 500 | 2 | 160 | 405 | 4 | 15 |
| 12 | 30 | 80 | 1000 | 2 | 260 | 510 | 2 | 14 |
| 13 | 40 | 85 | 500 | 0 | 210 | 510 | 2 | 15 |
| 14 | 30 | 90 | 500 | 2 | 260 | 300 | 2 | 15 |
| 15 | 35 | 80 | 1000 | 0 | 210 | 300 | 2 | 15 |
| 16 | 35 | 80 | 1000 | 2 | 160 | 405 | 4 | 15 |
| 17 | 35 | 85 | 1000 | 0 | 260 | 300 | 4 | 15 |
| 18 | 30 | 85 | 1000 | 2 | 210 | 300 | 4 | 13 |
| 19 | 40 | 90 | 1000 | 2 | 160 | 300 | 2 | 14 |
| 20 | 35 | 90 | 500 | 0 | 260 | 405 | 2 | 13 |
| 21 | 40 | 80 | 500 | 2 | 260 | 300 | 4 | 13 |
| 22 | 30 | 90 | 1000 | 0 | 210 | 405 | 4 | 13 |
| 23 | 40 | 80 | 500 | 2 | 210 | 405 | 2 | 15 |
| 24 | 30 | 80 | 500 | 0 | 160 | 300 | 2 | 13 |

In the third step (Conducting the experiment), the scientists and engineers perform the tests contained in the experimental design and take the measurements that they have planned during the Preparation step (Step 1). More concretely, they measure the attributes of the raw material that they used which were identified in Step 1 as potentially having an influence on the responses, and they measure the responses themselves.

In our example, seven additional columns that are added to the experimental design table in Table 3:3 columns for the attributes of the raw material (moisture, particle size and age), and 4 columns corresponding to the measured responses (residual left in the product, density, thermal degradation, and extrusion pressure). The extra columns added to Table 1 after the execution of the experiment are depicted in Table 5.

TABLE 5

| | Attributes of the raw material | | | Responses | | | |
|---|---|---|---|---|---|---|---|
| | | Particle | | | | Thermal | Extrusion |
| | Moisture | size | Age | Residual | Density | degradation | pressure |
| Test | (% ERH) | (μm) | (days) | (ppm) | (g/L) | (° C.) | (Mpa) |
| 1 | 1320 | 90 | 20 | 7.05 | 91 | 5057 | 1.75 |
| 2 | 1325 | 76 | −10 | 11.56 | 94 | 61 | 1.05 |
| 3 | 1330 | 64 | 0 | 7.14 | 87 | 241 | 0.41 |
| 4 | 1323 | 81 | −14 | 9.79 | 90 | 134 | 0.7 |
| 5 | 1318 | 82 | 12 | 7.92 | 92 | 2267 | 0.64 |
| 6 | 1316 | 92 | −3 | 7.37 | 92 | 499 | 0.31 |
| 7 | 1316 | 87 | 5 | 8.47 | 90 | 4903 | 1.43 |
| 8 | 1315 | 91 | 0 | 10 | 90 | 4143 | 1.95 |
| 9 | 1315 | 91 | −20 | 8.49 | 92 | 140 | 0.68 |
| 10 | 1313 | 75 | −15 | 9.38 | 88 | 286 | 0.5 |
| 11 | 1330 | 96 | 5 | 6.9 | 92 | 198 | 0.41 |
| 12 | 1329 | 97 | 15 | 6.82 | 91 | 3472 | 1.1 |
| 13 | 1332 | 88 | −6 | 8.88 | 90 | 2916 | 1.51 |
| 14 | 1330 | 88 | 13 | 5.99 | 91 | 4026 | 0.69 |
| 15 | 1329 | 88 | 0 | 8.77 | 91 | 6569 | 1.2 |
| 16 | 1330 | 90 | 0 | 8.37 | 93 | 134 | 0.49 |
| 17 | 1329 | 92 | 25 | 8.17 | 90 | 584 | 0.73 |
| 18 | 1333 | 93 | −10 | 7.78 | 90 | 509 | 0.24 |
| 19 | 1329 | 85 | 20 | 9.92 | 91 | 6382 | 0.91 |
| 20 | 1332 | 85 | 12 | 8.42 | 92 | 1395 | 1.48 |
| 21 | 1329 | 91 | 23 | 10.85 | 87 | 330 | 0.35 |
| 22 | 1332 | 93 | −11 | 5.55 | 93 | 373 | 0.55 |
| 23 | 1328 | 87 | 0 | 11.75 | 92.00 | 1612 | 0.28 |
| 24 | 1334 | 90 | −16 | 4.14 | 94 | 5437 | 0.9 |

In the fourth step (Analysis of the results), a model or models are estimated from the experimental data. The model or models relate the inputs (factors and attributes of the raw material), to the outputs (responses). Different types of modeling techniques can be considered.

Each estimated model with one of the techniques listed in Table 1 (or other applicable method), consists of a mathematical expression that relates the controllable and uncontrollable factors with one or more responses. The advantage of having such a model is that it allows the prediction of the behavior of the system of study for values of the factors that have not been tested.

In our example, the modeling technique chosen was linear regression. Following with the example of the chemical industry, we will show and illustrate different linear regression models. First, consider the coding of the variables as displayed in Table 6.

TABLE 6

| | Coded factor |
|---|---|
| Factor name | name |
| Water (l) | X₁ |
| Acid 1 (mg/l) | X₂ |
| Acid 2 (mg/l) | X₃ |
| Base (mg/l) | X₄ |
| Amount solvent (mg/l) | X₅ |
| Temperature oven (° C.) | X₆ |
| Time in the oven (h) | X₇ |
| Pressure (MPa) | X₈ |
| Moisture (% ERH) | Cov1 |
| Particle size (μm) | Cov2 |
| Age (days) | Cov3 |

Likewise, we consider the following coding of the responses in the chemical experiment as displayed in Table 7.

TABLE 7

| | Coded |
|---|---|
| Original name | name |
| Residual (ppm) | y^{r} |
| Density (g/L) | y^{d} |
| Thermal degradation (° C.) | y^{td} |
| Extrusion pressure (Mpa) | y^{ep} |

The goal in analysis and modeling step is to find a meaningful linear regression model. A linear regression model is defined by the choice of the active effects in the model. Choosing the effects to be included in the model is a problem known as “model selection”. Model selection becomes a challenge, when, as in the example, there are many different effects that can be considered. If you consider all the effects in a model with a constant, main, two-factor interaction and quadratic effects, the number of effects that we can consider to choose a linear regression model for the response y^{r} is displayed in Table 8.

TABLE 8

| | Number of |
|---|---|
| Effect type | effects |
| Constant | 1 |
| Main effects | 11 |
| Two-factor interaction effects | 55 |
| Quadratic effects | 10 |
| Total | 77 |

Now, consider two linear regression models that relate the response “Residual (ppm)”, denoted as y^{r}, with the factors, which are coded from x₁ to x₁₁. Tables 9 and 10 show the chosen effects for each one of the models and the significance p-values for each one of the estimates.

TABLE 9

| Effect | Estimate | p-value |
|---|---|---|
| Intercept | 0.845 | 0 |
| X3 | 0.221 | 0.00004 |
| X4 | −0.221 | 0.00002 |
| X6 | 0.142 | 0.00716 |
| X7 | −0.223 | 0.00005 |
| Cov1*X3 | −0.270 | 0.00107 |

TABLE 10

| Effect | Estimate | p-value |
|---|---|---|
| Intercept | 0.884 | 0 |
| Cov1 | −0.172 | 0.01967 |
| X3 | 0.236 | 0.00004 |
| X4 | −0.201 | 0.00012 |
| X7 | −0.216 | 0.00017 |
| Cov1*X3 | −0.330 | 0.00033 |

To assess how good are these models from the statistical point of view, we present Table 11, where several quality indicators of the two linear regression models are displayed.

TABLE 11

| | Model 1 | Model 2 |
|---|---|---|
| Number of effects | 5 | 5 |
| R2 | 0.886 | 0.873 |
| Adjusted R2 | 0.854 | 0.838 |
| AICc | −2.261 | −4.7508 |
| BIC | −0.1338 | 2.3175 |
| Heredity | weak | strong |

Statistically speaking, there is little difference in quality between these two models. Yet, the conclusions that can be derived for each one of them are very different. For example, in model 1 the factor X6 has a positive effect estimate for its main effect (equal to 0.1424), while in model 2 this effect is not present. Likewise, the main effect of the factor Cov1 is present in model 2 (with a negative estimate of −0.172) but not in model 1. The R2 and the adjusted −R2 is better for model 1,but the AICc is better for model 2.

Having different models that explain equally well the data is a challenge for the statistician who is looking for the best meaningful model. It is the subject matter expert, this is, the scientists and engineers involved in the experiment, who can discern between models 1 and 2, as they have expertise in the process that have been studied, and they can, for example, indicate that the main effect of factor X6 should be in the model, as they have observed this behaviour in practice. There is a clear need to enable the communication between statisticians and scientists and engineers in Step 4.

Our novel interactive graph to show a number of competing models from different angles answers this need, as it is used as an instrument to enable the transfer of knowledge between the subject matter experts and the statisticians towards the finding of the best meaningful statistical model.

The models displayed in Tables 9 and 10 are graphically represented in a heatmap, by coloring the cells according to the size and sign of the effect estimates. FIG. 3 represents a heatmap with two rows that represent graphically the two models. One can see that the size of the estimate for the intercept is much higher than the other estimates in absolute value. This makes the heatmap more difficult to read, and therefore we build another heatmap without the intercept, so that the colors represent better the size and sign of the estimates other than the intercept (FIG. 4). In FIG. 4 it can be seen at first sight how the estimate for the main effect of factor x₅ has a different sign in both models.

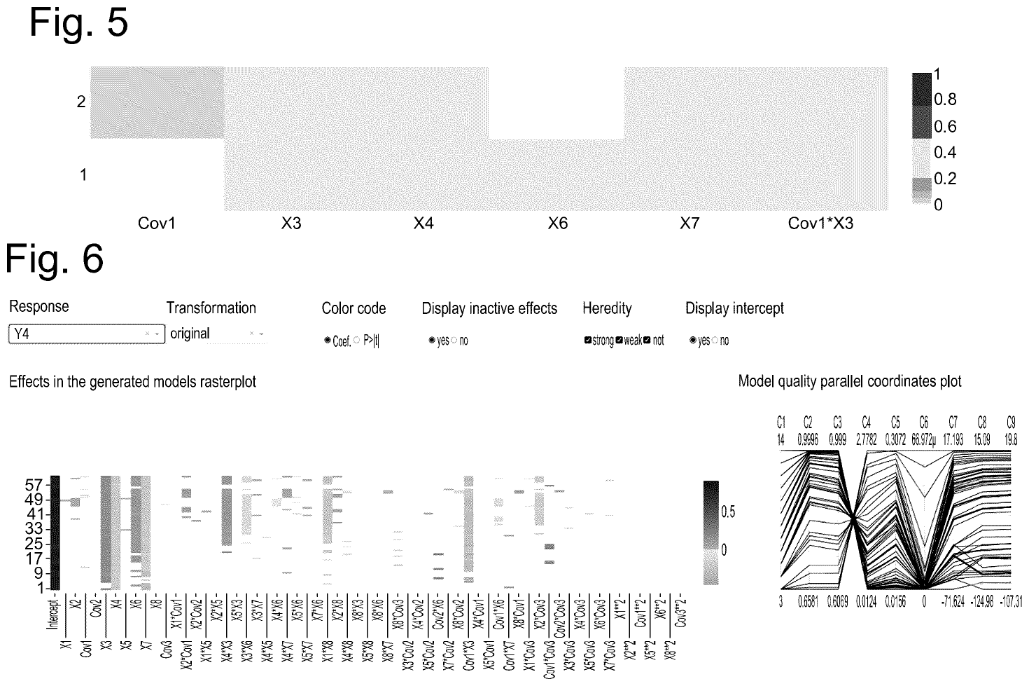

Instead of using the estimates for the different effects, one can also use the p-values for each effect to build the heatmaps. FIG. 5 shows how such a heatmap based on p-values can be constructed for Models 1 and 2. In this heatmap a discrete colorscale has been used. This color scale uses a the lightest blue to depict p-values between 0 and 0.01, then a less light blue color for p-values between 0.01 and 0.05, a dark blue color for p-values between 0.05 and 0.10, a light red color for p-values between 0.1 and 0.2, and finally, a dark red color for the rest.

The information on this model shows that all effects considered are significant at a level of 0.01 except for the main effect of Cov1 in model 2, which has a p-value of 0.01967.

The representation in FIGS. 3 to 5 are redundant when there are just a few models. However, the situation change when size of the set of the candidate models increases.

FIG. 6 shows a heatmap and the accompanying parallel coordinate plot with 62 models for response y_{d} and the factors specified in Table ?. The heatmap in FIG. 6 is colored according to the size and sign of the estimates of the effects.

Next we are going to show in different screenshots how the controls on the top, the heatmap and the parallel coordinate plot interact with each other.

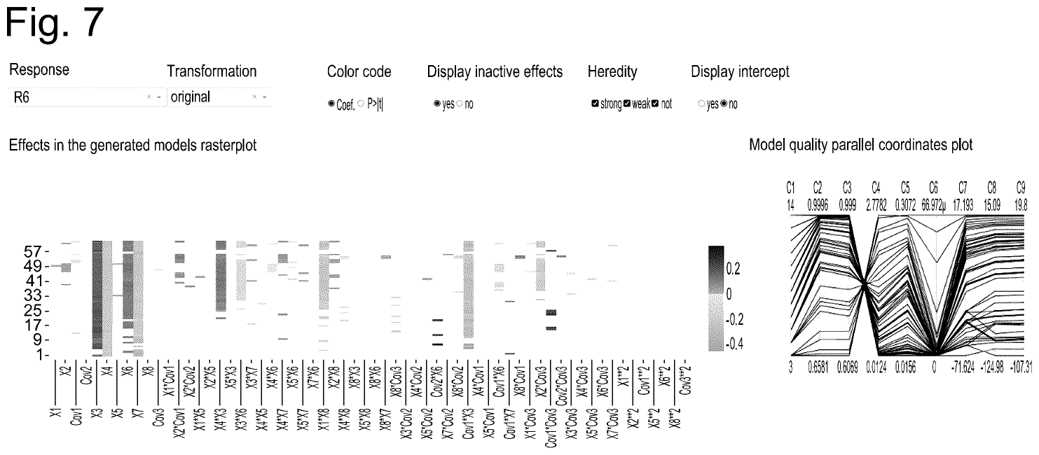

FIG. 7 is the same as FIG. 6 but without the intercept column in the heatmap (as the radiobutton has been activated to not show the intercept column).

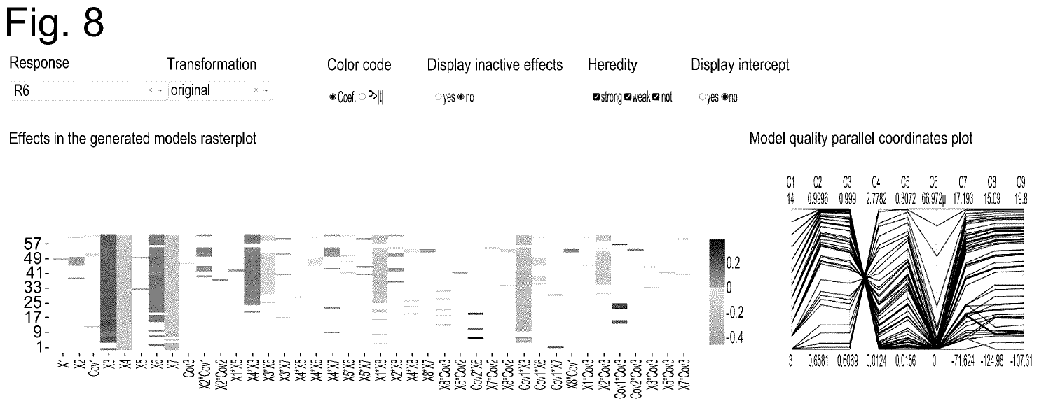

FIG. 8 is the same as FIG. 7 but without the columns of effects that do not appear in any of the 62 models (as the radiobutton has been activated to not show these columns)

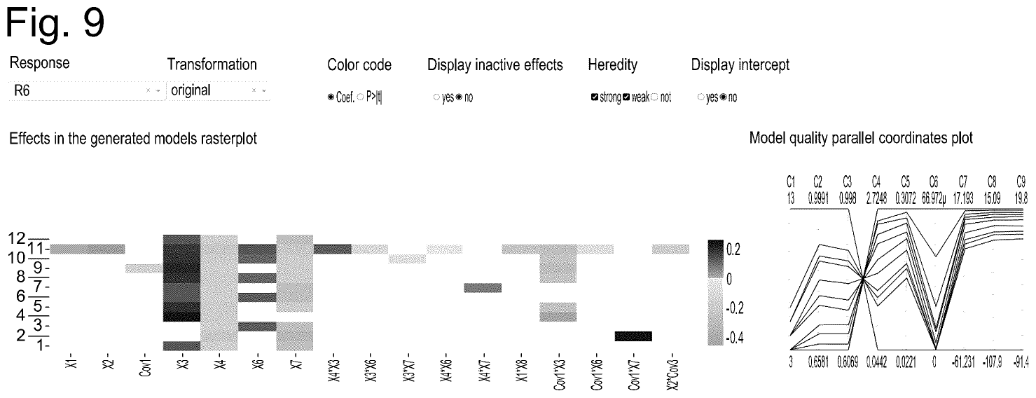

The upper controls can be additionally used to not display the models with no heredity. In FIG. 9 there are just 12 models with weak or strong heredity. Both the heatmap and the parallel coordinate plot have been constructed by taking only these 12 models into account.

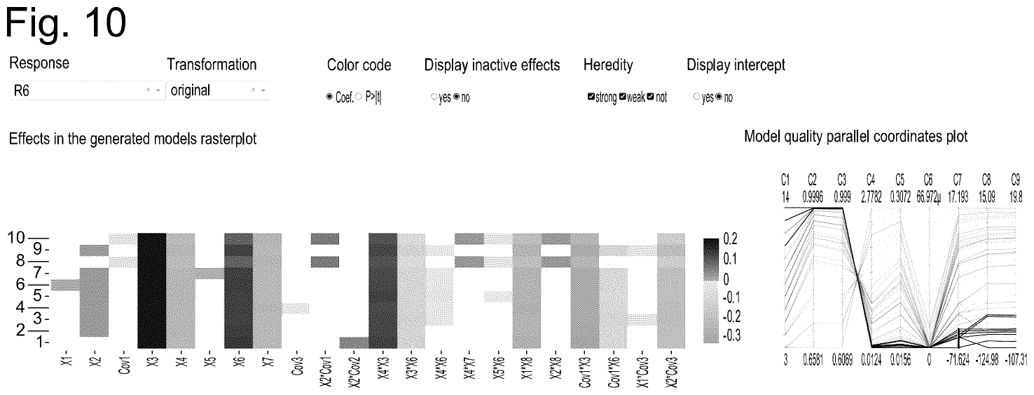

Starting from the initial 62 models, FIG. 10 shows how we can use the parallel coordinate plot to impose constraints on one or several quality indicators of the models. In FIG. 10 we have imposed a value for the AICc criterion no larger than −40. One can see how the main effect of factor X6 appears in all models with a consistently positive value for its estimate. This graph gives evidence to prefer model 1 instead of model 2.

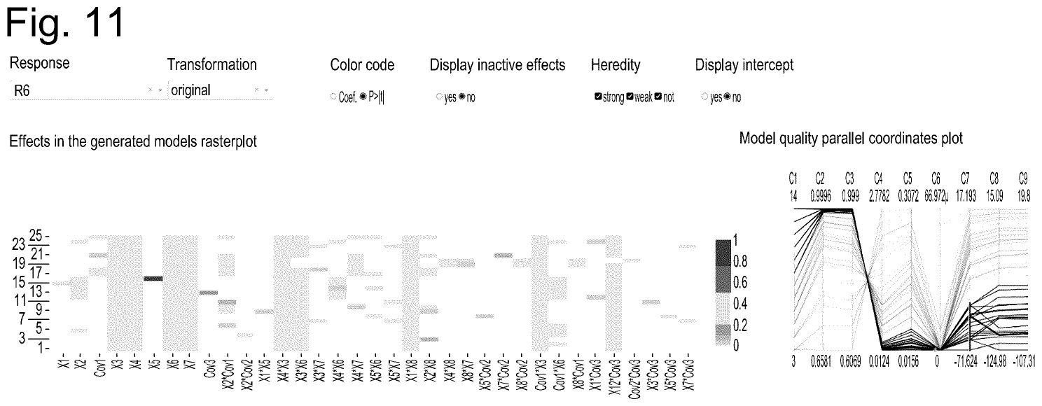

The information on the effects for each model displayed in the heatmap can be colored using the p-values instead of the size of the estimates. FIG. 11 shows how, after activating the corresponding radio button in the upper controls, the heatmap represents with a colorscale the p-values of the estimates of the effects.

The graphs for modeling that we have presented allows the statistician to interact with subject matter experts (scientists and engineers), so that all together find a meaningful model or models for the problem at hand.

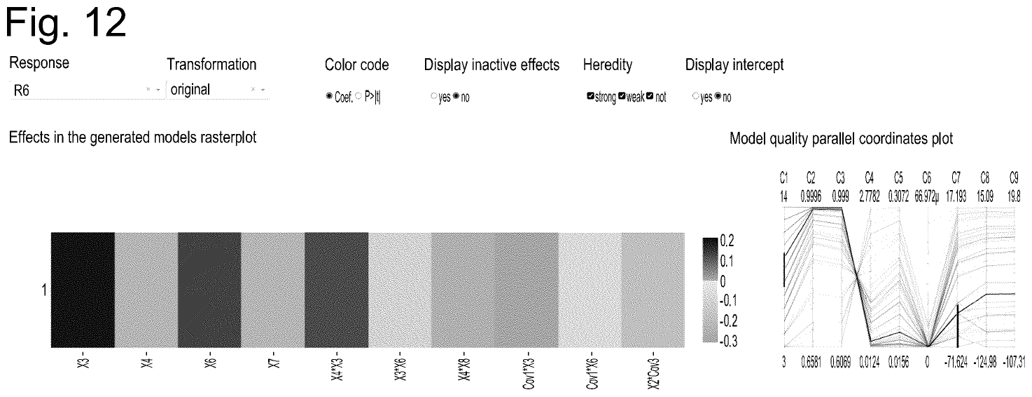

Finally, our graphical interactive tool can also be used for selecting a final model. In FIG. 12 we have imposed constraints in the parallel coordinate plot such that there is only one model selected, which appears in the heatmap that in this case contains a single row.

In the fifth step, the different people involved in the project define what are the values of the responses for an efficient process or product (the system being studied). For example, if one of the responses is energy cost, and the other is resistance to compression, then the specifications for a successful system can consists of minimizing the energy cost while maximizing the resistance of compression. The model or models obtained in the previous step are the base for the optimization. The optimization has as goal the definition of a factor values combination such that all responses lie within the set specifications and/or optimization goals.

In our example, the scientists have a clear idea on what the specifications for a compliant product are:
Y1 should be on an interval from 6 to 12
Y2 should be minimized, with an upper bound of 93.
Y3 should be minimized.
Y4 should be minimized with an upper bound of 1.5

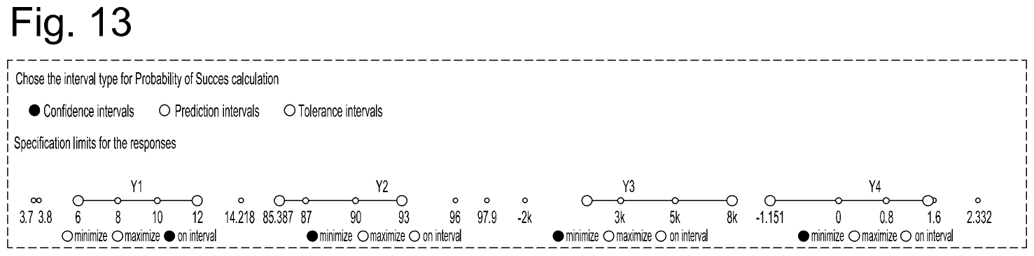

The specifications are set using range sliders and radiobuttons to set the optimization direction (minimization, maximization, or on an interval). FIG. 13 displays how the specifications are set in the graphical interface. FIG. 13 shows a plurality of controls 1304 comprising range sliders 1304 and radiobuttons 1302 and 1306 to set the optimization direction (minimization, maximization, or on an interval) of the specifications.

### Prediction Capabilities of the Linear Regression Models

The model or models obtained in the previous step are able to predict what value the response or responses will take for a factors value combination that lies within the range that has been defined in Table 3. For example, the predicted value using model 1 in Table 9 equals the following expression

$$= 0.8474 + 0 \text{.2209} \cdot X 3 - 0 \text{.2206} \cdot X 4 + 0 \text{.1424} \cdot X 6 - 0.2289 \cdot X 7 - 0.2696 \cdot Cov 1 * X 3$$

Consider the factor combination value displayed in Table 12 (where the values are scaled to be within the interval [−1,1]).

If we would like to know what is the predicted value for the response Y4 at that factor combination value, we will obtain a value of

$$= 0.8474 + 0 \text{.2209} \cdot ( - 1 ) - 0.2 \; 206 \cdot 1 + 0.1424 \cdot 0 - 0.2289 \cdot 1 - 0.2696 \cdot 0.5 * ( - 1 ) = 0.3118$$

This means that the predicted residual at the factor combination value in Table 12 equals 0.3118, which is below the specifications.

Each prediction has a variance, which can be used to set the confidence interval and the prediction interval. The confidence interval (CI) for the predicted mean response at a given factor combination values equals

$$CI = \hat{Y} \pm {t}_{n - p}^{α / 2} \hat{σ} \sqrt{{{x}^{T} ( {X}^{T} X )}^{- 1} x} ,$$

where Ŷ is the predicted response, tₙ₋ₚ^{α/2} is the t-statistic with n−p degrees of freedom at the α/2 quantile, \hat{σ} is the estimation of the error standard deviation, x is the column vector of the effects in the model with substitution of the factor values, and X is the model matrix used to estimate the model.

The prediction interval (PI) for the single predicted response at a given factor combination values equals

$$PI = \hat{Y} \pm {t}_{n - p}^{α / 2} \hat{σ} \sqrt{{{x}^{T} ( {X}^{T} X )}^{- 1} x + 1} .$$

Measure of How Good the System Complies with the Specifications at a Given Factor Combination Values

Consider a linear regression model for a certain response Y. To quantify how good a predicted response at a given factor combination values performs we do the following:
If the optimization direction is set to minimization, assuming there is an upper bound value (UB), we calculate the maximum value of α such that the upper limit of the confidence/prediction interval equals the UB. The value of 1−α is a number between 0 and 1 that quantifies the performance as follows: 1 is the best value and 0 is the worst.
If the optimization direction is set to maximization, assuming there is an lower bound value (LB), we calculate the maximum value of α such that the lower limit of the confidence/prediction interval equals the LB. The value of 1−α is a number between 0 and 1 that quantifies the performance as follows: 1 is the best value and 0 is the worst.
If the optimization direction is set to on interval, assuming there is a lower and an upper bounds values (LB, UB), we calculate the maximum value of α such that the upper limit of the confidence/prediction interval equals the UB (denoted as α_{UB}) and the maximum value of a such that the lower limit of the confidence/prediction interval equals the LB (denoted as α_{LB}). The value of 1−max (α_{UB}, α_{LB}) is a number between 0 and 1 that quantifies the performance as follows: 1 is the best value and 0 is the worst.

Now consider a scenario where there are multiple responses and specifications for each one of them. The measure of how good all responses comply with the specifications at a given factor combination is calculated by multiplying the single measures for all responses.

### Graphically Representation of the Values for the Predicted Responses for a Grid of Factor Combination Values and the Measure of How Good They Lie Within Specifications (Measure of Compliance).

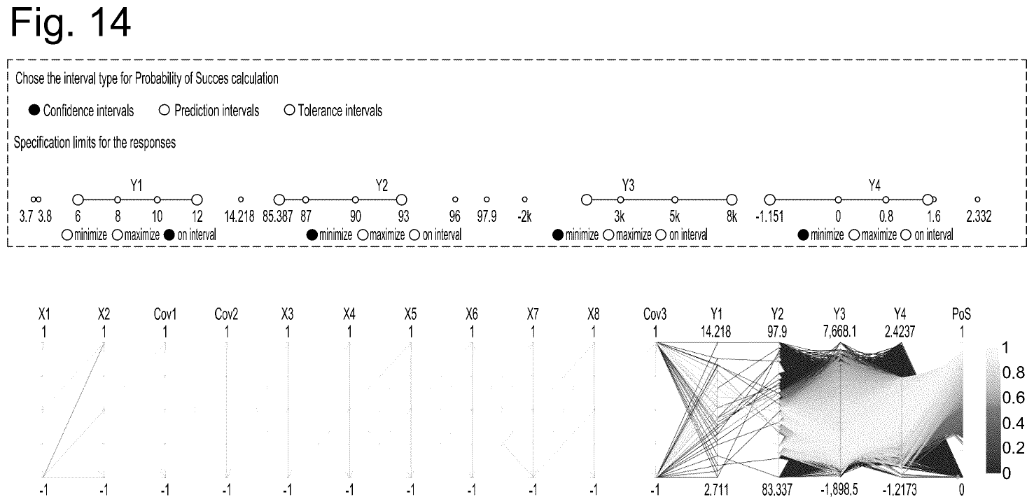

FIG. 14 shows a graphical interface with the predicted responses for a grid of factor combination values together with the measure on how good factor combination values produces responses values that lie within the given specifications. From left to right we find one vertical axis for each factor value, then one vertical axis for each predicted response, and, finally, the right vertical axis corresponds to the measure of the compliance with the response specifications. A single line from left to right represents a single factor combination values, the predicted responses, and the measure of compliance with the response specifications. Each line is coloured according to the value of the measure of compliance (which goes from 0 to 1).

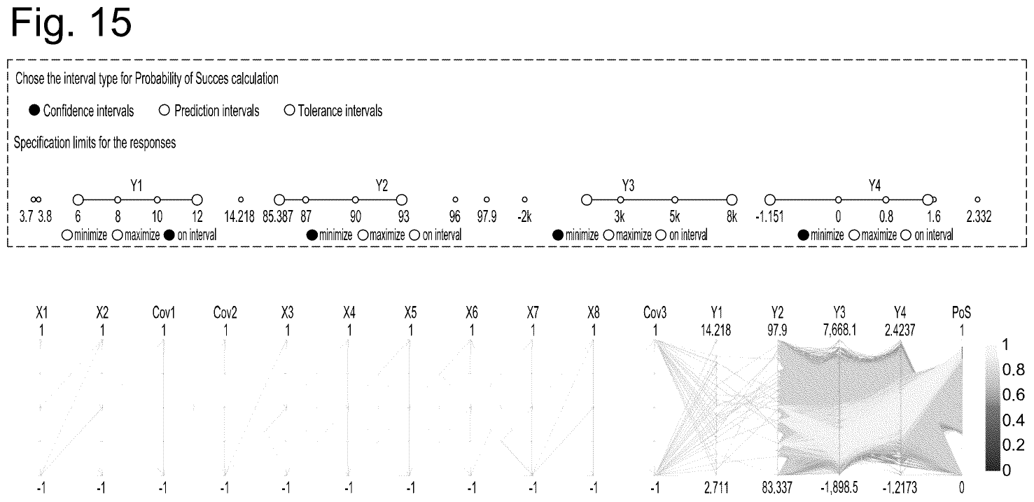

The graph in FIG. 14 is very useful to explore a high dimensional space (in the factors and the responses). It is an interactive graph, where a user can set constraints on any of the vertical axis. FIG. 15 shows a constraint on the last vertical axis, the corresponding to the measure of compliance. A constraint has been set such that only the lines with a high measure of compliance are selected. The rest of points are greyed out. For example, the line that joins a low value for factor X1 and a low value for factor X2 is greyed out, which means that to achieve a high measure of compliance, factors X1 and X2 cannot be set both at their lowest level. A similar observation can be made with a low level for the factor Cov2 and a high level for factor X3.

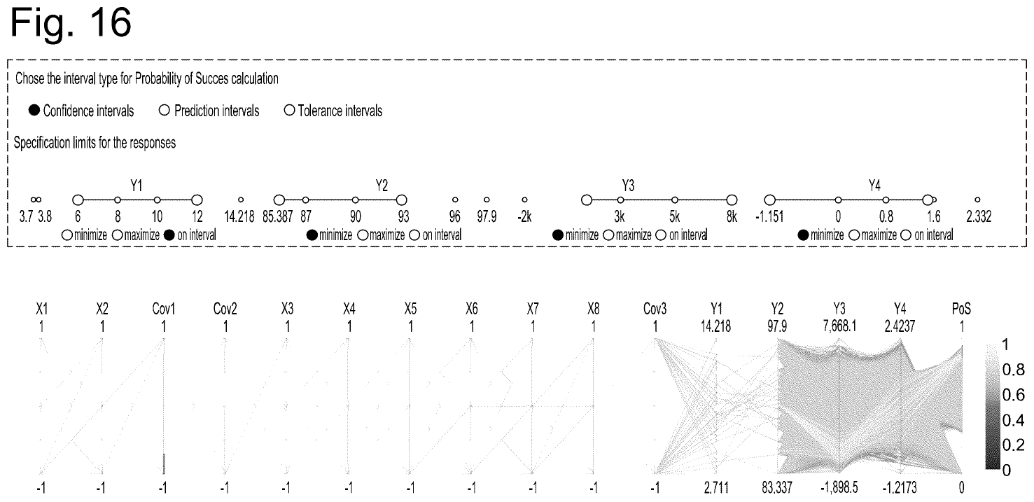

Multiple constraints can be set. In FIG. 16, an additional constraint on factor Cov1 is imposed. In this case we can see that more lines are greyed out, which indicates that certain levels of the factors cannot be used to achieve a compliant system.

Using this graph for statistical modelling optimization has never been used, and its ability to explore multidimensional data has been proved in several industrial cases.

Generality of the Optimization Interface for Other Measures of Compliance with Different Modeling Technique Other than Linear Regression

The graph in FIGS. 14-16 is general and it can be used with other statistical modeling techniques. For example, a Gaussian process can be used, and the prediction intervals can be used to calculate a measure of compliance. In classification problems, several measures of compliance can be used, like the false positives and the false negatives.

Further, other axis can be added to the graph, like the prediction variance of each factor combination values at each response, or any other measure that characterizes the performance of each factor combination values for a given set of specifications.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A computer-implemented method for modelling a data set using a graphical interface, the method comprising:
displaying, in a display screen by an operating system, a heatmap plot for a plurality of inputs and a plurality of mathematical models, the heatmap plot comprising a plurality of cells wherein each cell corresponds to an input of the plurality of inputs and a mathematical model of the plurality of mathematical models, wherein each cell comprises a visual indication of the sign and absolute value of a value associated to the corresponding input and to the corresponding model;
receiving a first user input selecting cells corresponding to a certain value or range of values among the plurality of cells; and
modifying the heatmap plot and the parallel coordinate plot based on the first user input;
wherein each of the mathematical models describes the relation between the plurality of inputs and the plurality of outputs wherein the plurality of inputs are inputs of a system or process and the plurality of responses are outputs of the system or process affected by variations in the inputs.

2. The computer-implemented method according to claim 1, wherein the visual indication comprises a colour.

3. The computer-implemented method according to claim 2, wherein the colour is different depending on whether the sign of the corresponding value is positive or negative.

4. The computer-implemented method according to claim 1, wherein the colour of a first cell of the plurality of cells is darker than the colour of a second cell of the plurality of cells if the absolute value of the corresponding effect for the first cell is greater than the absolute value of the corresponding effect for the first cell.

5. The computer-implemented method according to claim 1, wherein the plurality of effects comprise a intercept effect and the method further comprises:
displaying, in a display screen by an operating system, graphical controls for selecting whether the heatmap plot displays a constant input among the plurality of inputs and/or cells among the plurality of cells corresponding to inputs that have a zero value for each of the plurality of mathematical models and/or cells corresponding to mathematical models comprising a predetermined statistical quality parameter;
receiving, by the operating system, a second user input for one of the graphical controls; and
displaying, in the display screen by the operating system, the heatmap plot modified according to the second user input.

6. The computer-implemented method according to claim 1, further comprising:
displaying, by the processing unit in the display screen, a parallel coordinate plot for the plurality of mathematical models, the parallel coordinate plot comprising a plurality of vertical axis corresponding to a plurality of quality indicators of the plurality of mathematical models, and a plurality of lines connecting the plurality of quality indicators such that each line connects at least one point of each vertical axis with at least one point of the neighbouring vertical axis;
receiving a third user input selecting to display mathematical models complying with a constraint on at least one of the quality indicators among the plurality of quality indicators;
modifying the heatmap plot and the parallel coordinate plot based on the third user input such that only the mathematical models complying with a constraint on the selected quality indicators are displayed.

7. The computer-implemented method according to claim 6 further comprising receiving a fourth user input selecting to show mathematical models among the plurality of mathematical models comprising a transformation of an outcome among the plurality of outcomes, and modifying the parallel coordinate plot based on the fourth user input.

8. The computer-implemented method according to claim 1, further comprising:
displaying, by the processing unit in the display screen, a table for the plurality of mathematical models, the table comprising a plurality of vertical cells corresponding to a plurality of quality indicators of the plurality of mathematical models, receiving a third user input selecting to display mathematical models complying with a constraint on at least one of the quality indicators among the plurality of quality indicators,
modifying the heatmap plot and the table based on the third user input such that only the mathematical models complying with a constraint on the selected quality indicators are displayed.

9. A computer-implemented method for statistical modelling optimization, the method comprising:
receiving, by the processing unit, a plurality of inputs, each of the plurality of inputs corresponding to a continuous value or a categorical value, wherein the categorical value corresponds to a finite set of categories;
receiving, by a processing unit, a set of conditions for a plurality of outputs;
for each of the plurality of inputs corresponding to a continuous value, receiving a discretization number;
and displaying, by the processing unit in a display screen, a parallel coordinate plot comprising a vertical axis for each of the plurality of inputs, each of the plurality of outputs, and for at least one measure of compliance, each vertical axis comprising a number of points, and wherein the parallel coordinate plot further comprises lines connecting at least one point of each vertical axis with at least one point of the neighbouring vertical axis;
wherein the number of points of a vertical axis corresponding to an input among the plurality of inputs corresponding to a continuous value is calculated on the discretization value received for said input, the number of points of an input comprising a categorical value is based on the corresponding finite set of categories of said input, each of the points of a vertical axis of an output corresponds to a selection of a specific point in each vertical axis corresponding to an input and is calculated using a mathematical model corresponding to said input, and the at least one measure of compliance indicates a compliance of the calculated outputs with the set of conditions.

10. The computer-implemented method of claim 9 further comprising:
receiving, by the processing unit, a user input for at least one of the plurality of inputs, the plurality of outputs and the measure of compliance; and
modifying, by the processing unit, the parallel coordinate plot based on the user input; wherein the user input corresponds to a constraint for the at least one of the inputs, the plurality of outputs and the measure of compliance, and modifying the parallel coordinate plot comprises providing a visual indication of the lines in the parallel coordinate plot connecting points of the vertical axis complying with the constraint.

11. The computer-implemented method according to claim 9, wherein, if an output among the plurality of outputs comprises continuous values, a condition among the set of conditions corresponding to said output comprises an optimization direction that can be a minimization, a maximization, or an interval of the output given by an upper and a lower bound for a numerical value of said output.

12. The computer-implemented method according to claim 9, wherein, if an output among the plurality of outputs comprises categorical values within a finite set of categories, a condition among the set of conditions corresponding to said output comprises limiting the categorical value of said output to one or more categories among the finite set of categories.

13. The computer-implemented method according to claim 9, wherein the measure of compliance comprises at least one of a probability of the plurality of outputs complying with the set of conditions, a tolerance interval for said probability, a number of false positives or false negatives, a measures of robustness, or desirability function values.

14. The computer-implemented method according to claim 9, wherein at least one of the vertical axis and/or one of the lines comprises visual information indicating a value of the measure of compliance.

15. The computer-implemented method according to claim 14, wherein visual information indicating higher values of the measure of compliance comprises a first colour and visual information indicating lower values of the measure of compliance comprises a second colour different from the first colour.

16. An apparatus comprising a processing unit, a memory and a display wherein the processing unit is arranged to perform the method according to claim 1.
